(19) United States
(12) Patent Application Publication
(10) Pub. No.: US 2017/0169394 A1
(43) Pub. Date: Jun. 15, 2017

(54) Skill Set and Career Assessment Tool and Method

(71) Applicants: Kevin Brennfleck, Howell, MI (US); Kay Marie Brennfleck, Howell, MI (US)

(72) Inventors: Kevin Brennfleck, Howell, MI (US); Kay Marie Brennfleck, Howell, MI (US)

(21) Appl. No.: 15/380,141

(22) Filed: Dec. 15, 2016

Related U.S. Application Data
(60) Provisional application No. 62/267,322, filed on Dec. 15, 2015.

(51) Int. Cl. G06Q 10/10; G09B 7/02

(52) U.S. Cl. CPC G06Q 10/1053; G09B 7/02

(57) ABSTRACT

A skill set and career assessment tool and method is set forth devised to match users with results for available positions by generation of a code enabling automatic matching via network. A list of transferrable skills is presented to a user for sorting by preference and ranking by competency. A user also prioritizes ten favored skills. After the sorting, ranking, and prioritizing the code is generated to enable automated matching with results retrievable over network and available positions and opportunities suited to the user's enjoyment as well as skill set are displayed. Additionally, skills which the user may have competency in, but not enjoy using, are usable to display “killer skills”, that is results that would lead to success but lack of fulfillment for the user.

### CROSS-REFERENCE TO RELATED APPLICATIONS

This nonprovisional application claims the benefit of provisional application No. 62/267,322 filed on Dec. 15, 2015

### FEDERALLY SPONSORED RESEARCH OR DEVELOPMENT

Not Applicable

### INCORPORATION BY REFERENCE OF MATERIAL SUBMITTED ON A COMPACT DISK

Not Applicable

### COPYRIGHT NOTICE

Some portions of the disclosure of this patent document may contain material subject to copyright protection. The copyright owner has no objection to the facsimile reproduction by anyone of the patent document or ensuing disclosure as it appears on record at the Patent and Trademark Office, but otherwise reserves all copyright rights whatsoever.

### BACKGROUND OF THE INVENTION

Various types of skill set and career assessment tools and methods are known in the prior art. Other known skill set assessments focus on identifying skills but do not develop a code usable to retrieve occupations and opportunities matchable to a user's most enjoyed skills. What is needed is a skill set and career assessment tool and method that sorts a user's skill sets according to a preference level, indicative of enjoyment experienced when using a particular skill, and a competency level indicative of a user's proficiency in using said particular skill, to thereby retrieve job descriptions and/or education tracks suited to said user's competency and enjoyment.

### FIELD OF THE INVENTION

Not everyone enjoys performing tasks which they are effective performing. And enjoyment is not a suitable equivalence to competency. Thus the present invention provides a skill set and career assessment tool and method that enables a user to sort each of a plurality of transferable skills ranked by level of preference and competency whereby career paths, career and job descriptions, available openings in jobs, courses of study, or volunteer opportunities are matchable to the user by a code generable at conclusion of the method. When the instant tool and method is used in conjunction with networked computing apparatuses, the results of sorting the plurality of transferable skills may automate retrieval of appropriate data, including for example, career descriptions, education tracks, career paths, as well as availability in volunteer and other opportunities.

### SUMMARY OF THE INVENTION

The general purpose of the skill set and career assessment tool and method, described subsequently in greater detail, is to provide a skill set and career assessment tool and method which has many novel features that result in a skill set and career assessment tool and method which is not anticipated, rendered obvious, suggested, or even implied by prior art, either alone or in combination thereof.

The present skill set and career assessment tool and method has been devised to assist a user in determining a preferred career path or suitability for a particular opportunity or opening, or course of study, and facilitates matching a user with career choices, available opportunities, and courses of study, by generation of a code. A user is presented with a plurality of transferable skills and caused to select and rank them by proficiency and enjoyment, whereby a list of ten transferable skills is itemized and ranked. A code is generable from the sorted and ranked skills, said code usable for matched searching of career types, job descriptions, available opportunities, and openings via a network.

The present skill set and career assessment tool and method is best suited for automated administration and usability by a networked computing device, however the present tool and method is applicable for manual use wherein the particular skills are presented as cards positional interior to a matrix whereby the same code is generable by hand. An online platform accessible remotely by networked computer and runnable via network protocol is contemplated as part of this invention whereby automated retrieval of results is enabled for presentation to a user.

The present skill set and career assessment tool and method, therefore, includes presentation of a plurality of transferable skills for selection by a user. A user selects each of the plurality of skills and ranks them according to preference, between a maximum preference and a minimum preference. In a preferred embodiment herein disclosed, the plurality of transferable skills includes sixty skills identified literally. Each skill may be articulated upon a “card” or other virtual (or, in some embodiments, a real) object. A user selects each such skill and drags and drops it into a desired position significant of rank between a maximum preference level and a minimum preference level. In the example embodiment herein disclosed, there are four such preference levels including “I greatly like using these skills”, “I like using these skills”, “I dislike using these skills”, and “I greatly dislike using these skills”. A user thus drops each skill in turn into one of the displayed preference levels. Preference levels may be displayed as boxes, openings, or other graphical, virtual, or other objects.

Once each of the plurality of skills has been ranked accordingly, a user is then prompted to sort each of the transferable skills into a level of competency, ranking each between a “High Skill Level”, for example, a “Moderate Skill Level”, and a “Little or No Skill Level”. Thus the present skill set and career assessment tool and method assists determination of competency and enjoyment of a user's ability in exercising a particular transferable skill.

Once a user completes ranking each of the plurality of transferable skills by competency as well as by preference, a user is prompted to rank ten favored skills by priority—their favorite skill as number one and the less favorite skill as number ten. From these results a code is generable which is then executable through an automated search to match available openings and opportunities for particular career descriptions, jobs, careers, courses, and other such opportunities and openings, said opportunities and openings thereby matched to a user's preference and level of competency whereby a fulfilling and expedient role or career path for the user is likely engendered if the particular job description discovered is sought, or a matched opportunity or opening is attained.

Thus has been broadly outlined the more important features of the present skill set and career assessment tool and method so that the detailed description thereof that follows may be better understood and in order that the present contribution to the art may be better appreciated.

For better understanding of the skill set and career assessment tool and method, its operating advantages and specific objects attained by its uses, refer to the accompanying drawings and description.

### BRIEF DESCRIPTION OF THE DRAWINGS

### Figures

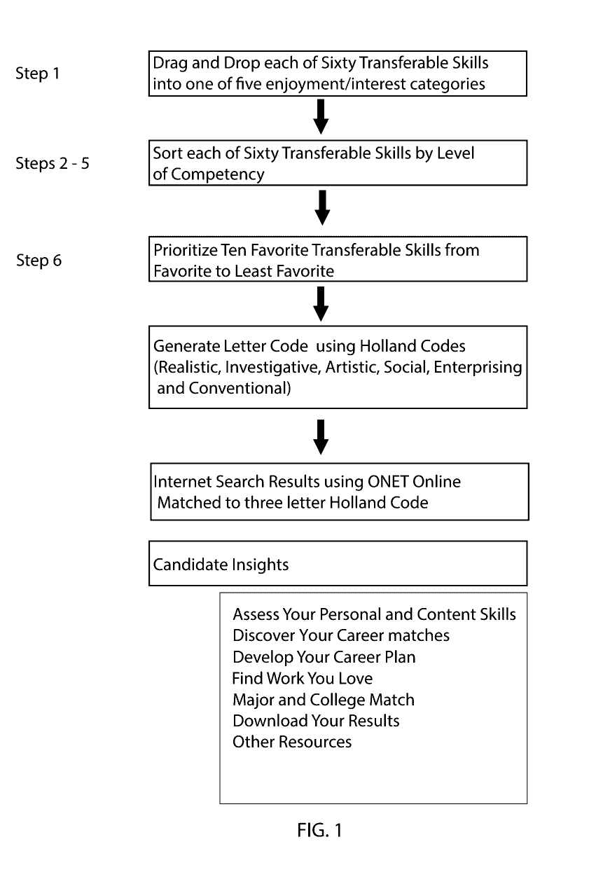

FIG. 1 is a flow diagram illustrating example steps of the present skill set and career assessment tool and method.

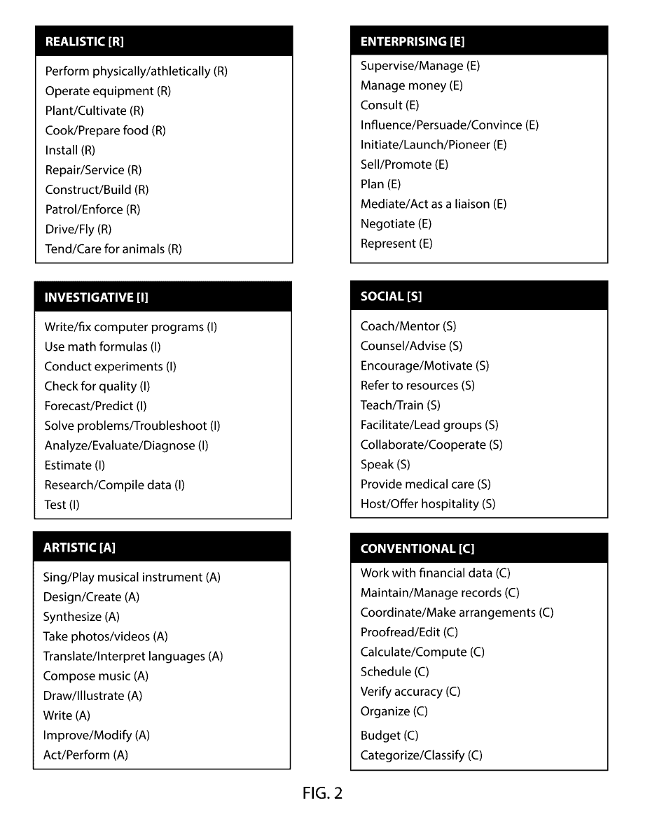

FIG. 2 is a literal view of each of a plurality of transferable skills and each of a plurality of designations.

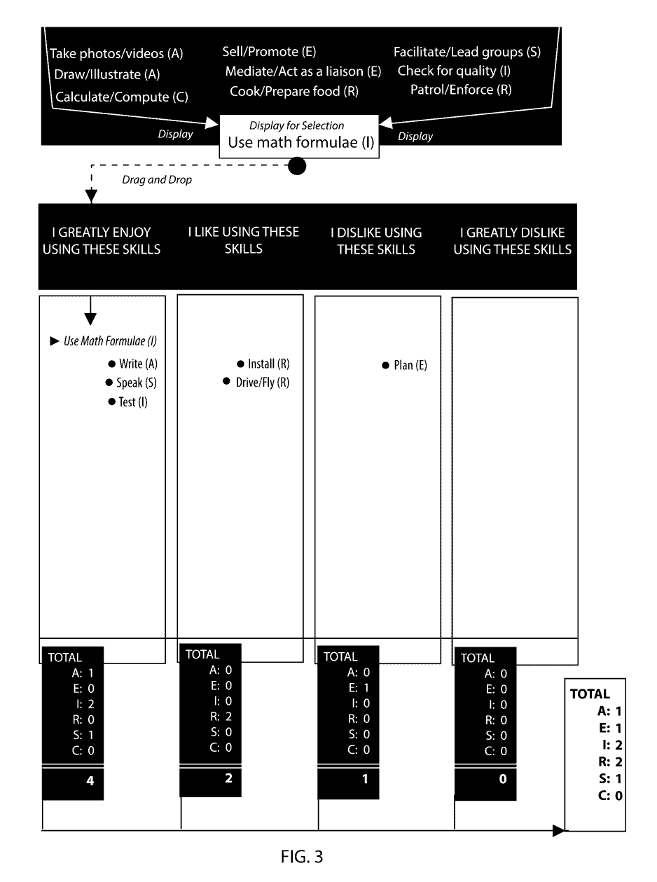

FIG. 3 is a conceptual view of a user sorting each presented transferable skill into a corresponding selected preference level.

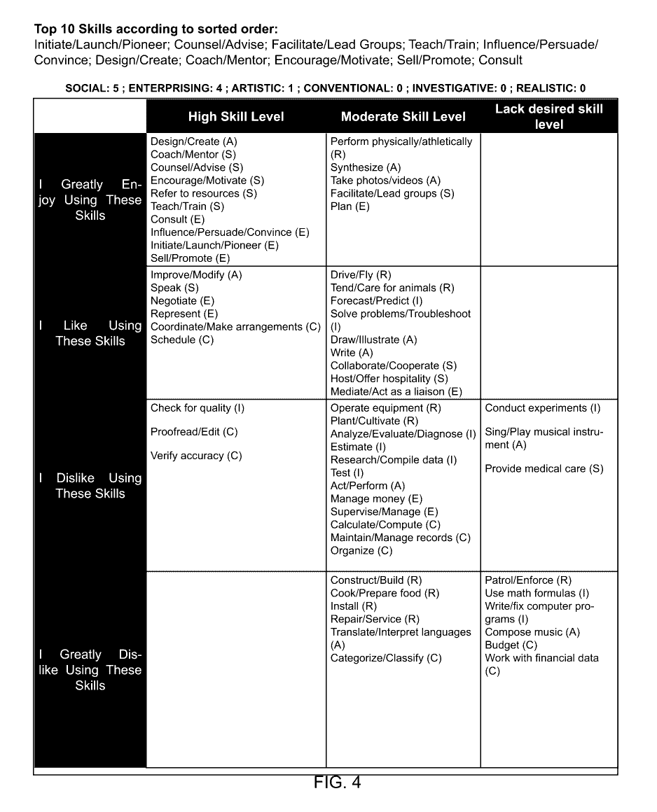

FIG. 4 is a table view of an example sort of each of the plurality of transferable skills into a matrix ranking each by competency level and preference level.

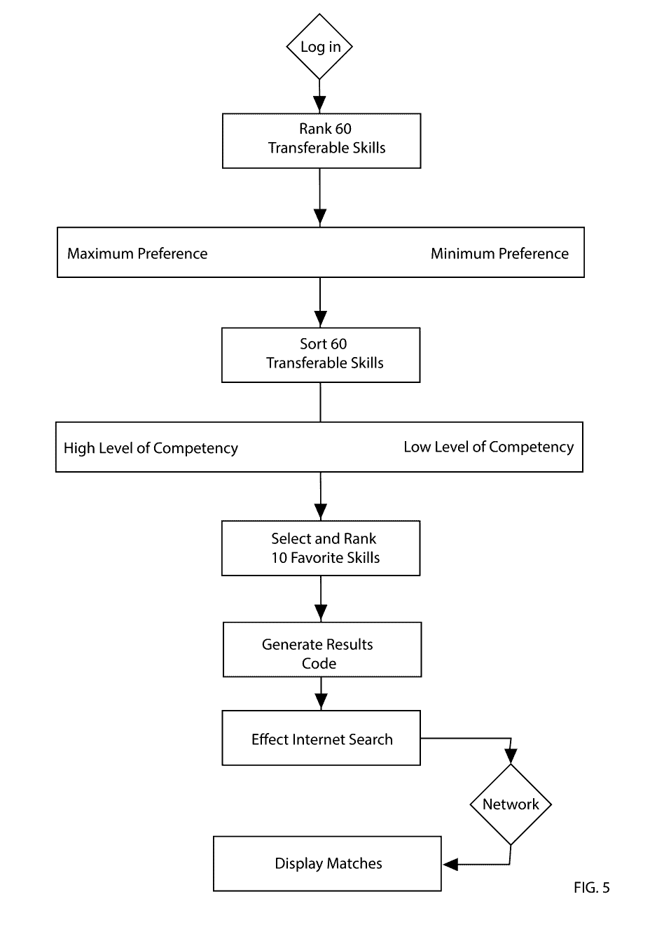

FIG. 5 is a logic diagram of an example embodiment of the present skill set and career assessment tool and method.

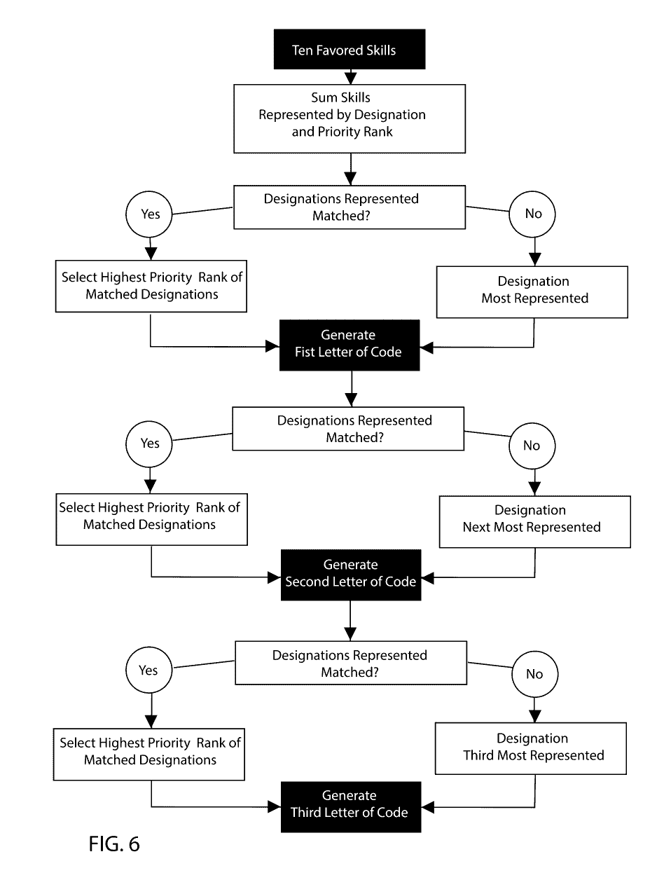

FIG. 6 is a logic diagram of generation of an example three-letter code.

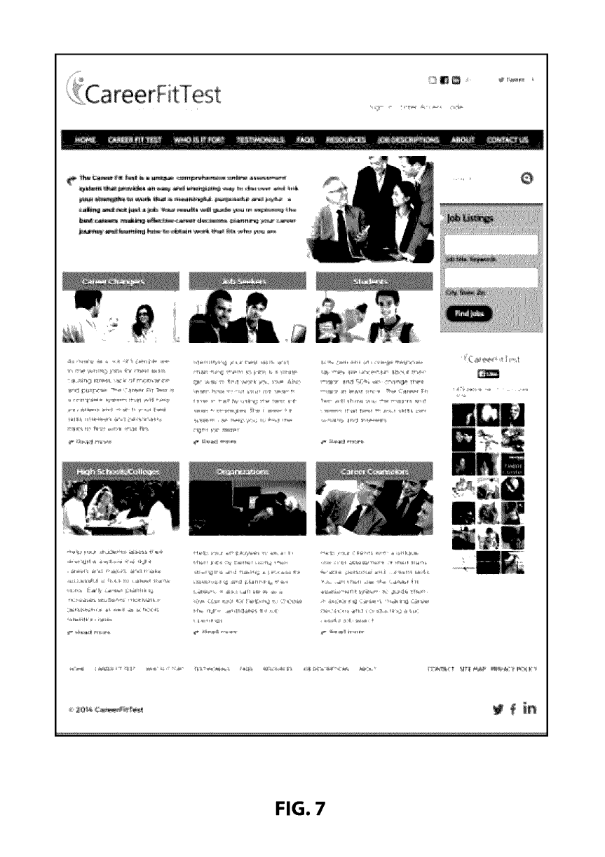

FIG. 7 is a screen shot of an example home page for a network based exemplification of the present tool and method.

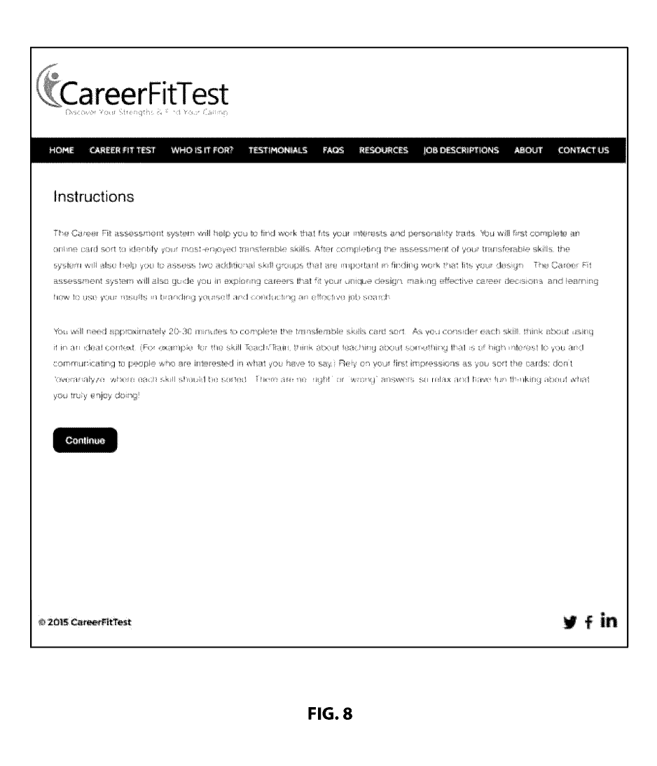

FIG. 8 is a screen shot of an example instructions page for a network based exemplification of the present tool and method.

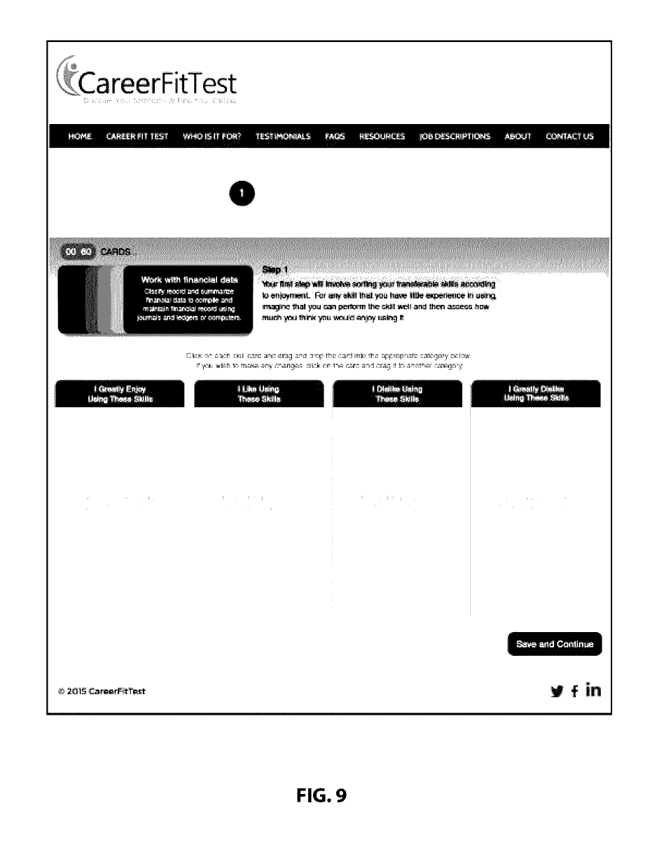

FIG. 9 is a screen shot of an example first step page for a network based exemplification of the present tool and method.

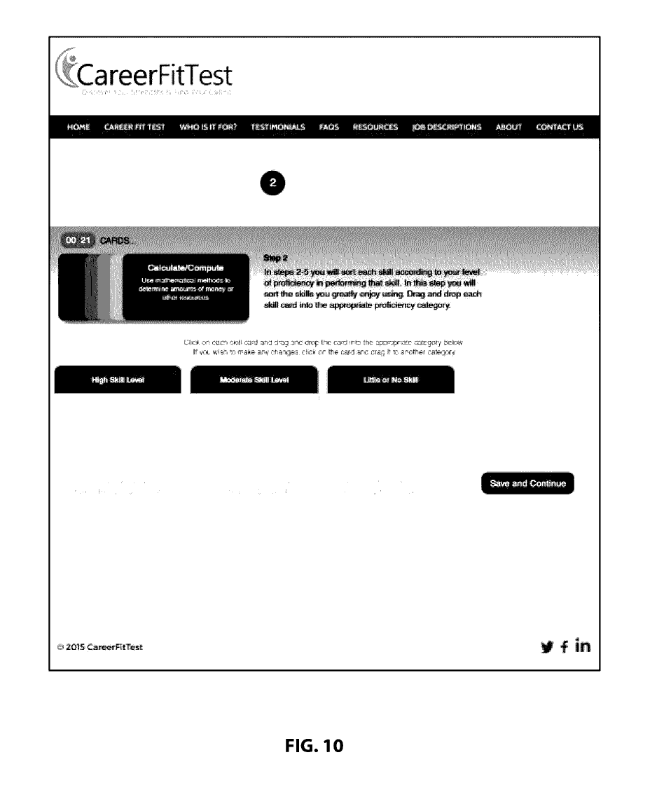

FIG. 10 is a screen shot of an example second step page for a network based exemplification of the present tool and method.

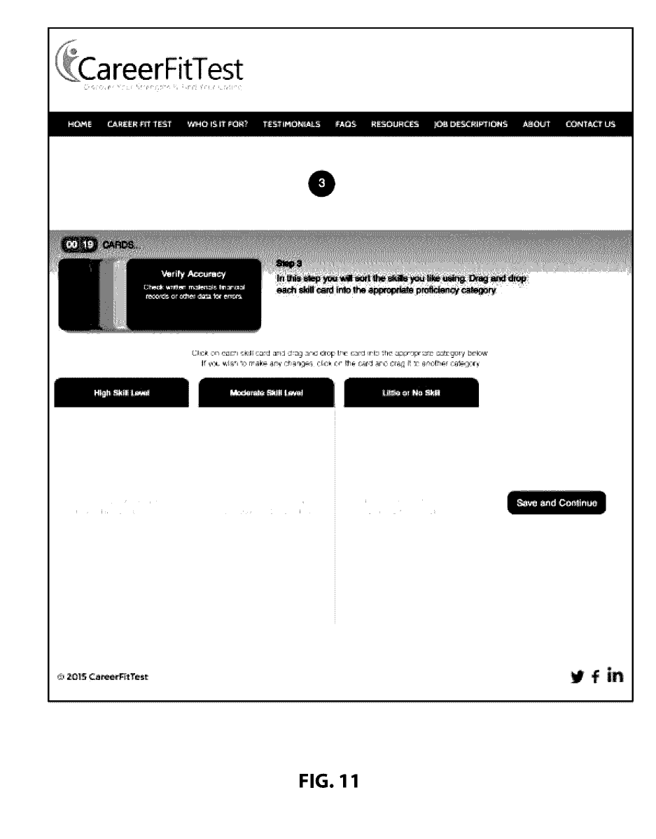

FIG. 11 is a screen shot of an example third step page for a network based exemplification of the present tool and method.

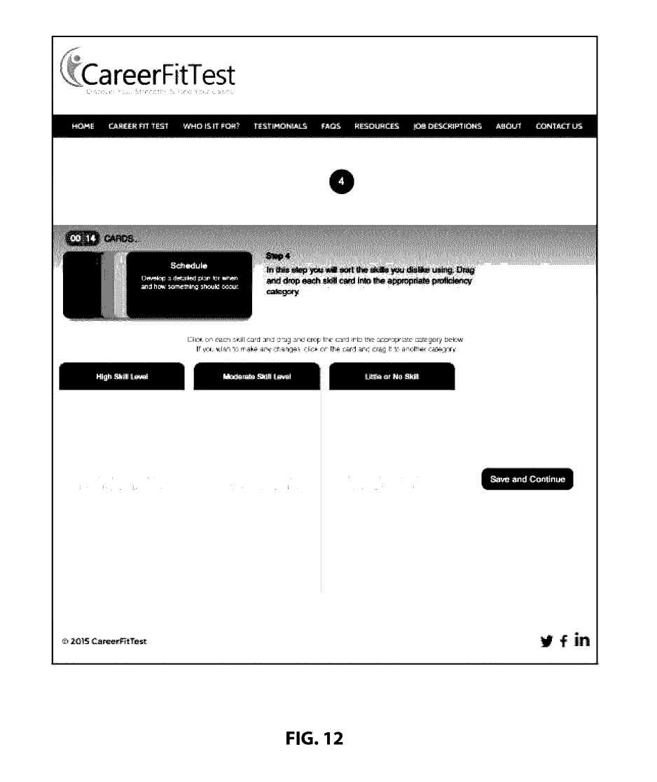

FIG. 12 is a screen shot of an example fourth step page for a network based exemplification of the present tool and method.

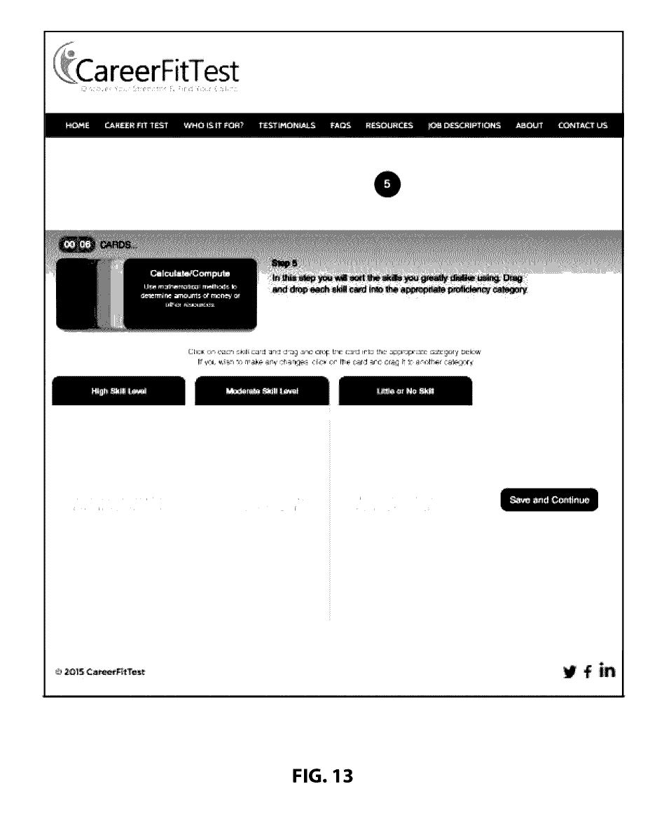

FIG. 13 is a screen shot of an example fifth step page for a network based exemplification of the present tool and method.

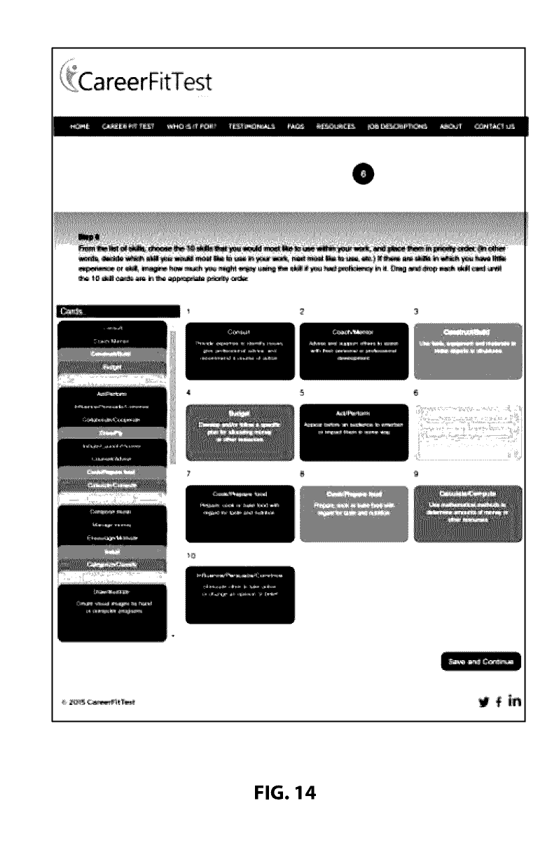

FIG. 14 is a screen shot of an example sixth step page for a network based exemplification of the present tool and method.

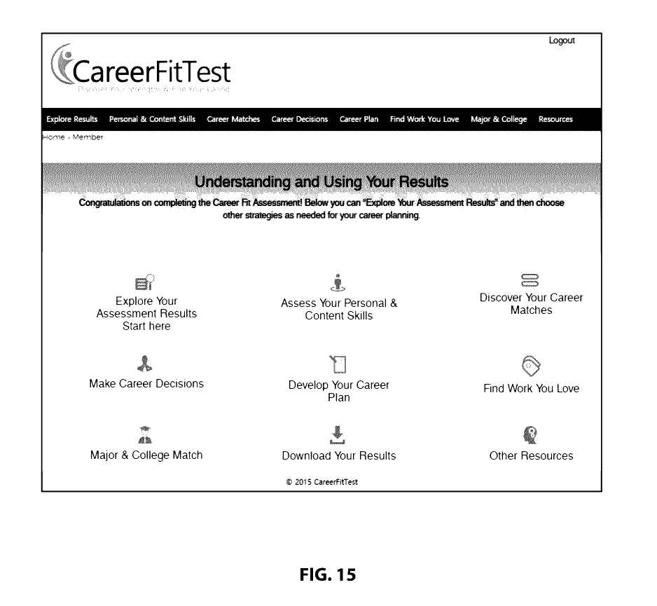

FIG. 15 is a screen shot of an example results page for a network based exemplification of the present tool and method.

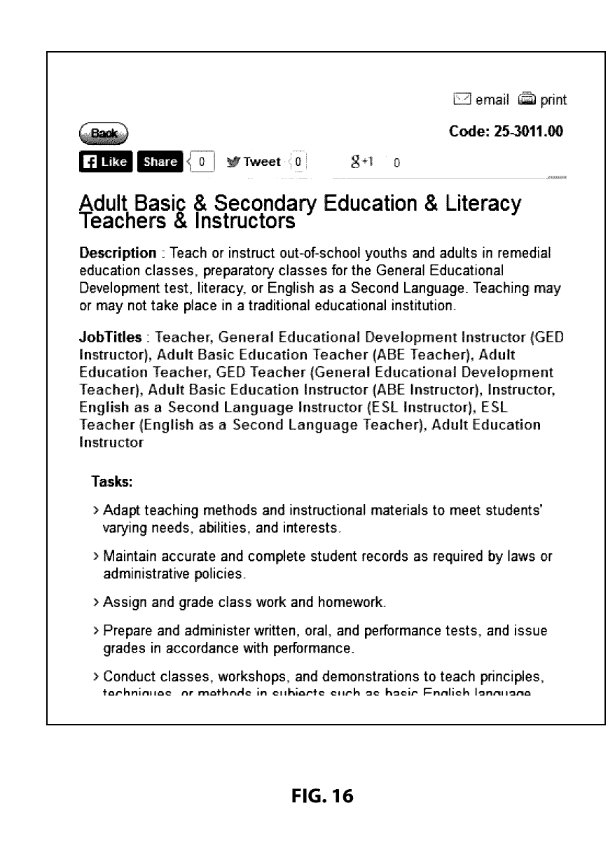

FIG. 16 is a screen shot of an example matched job description page for a network based exemplification of the present tool and method.

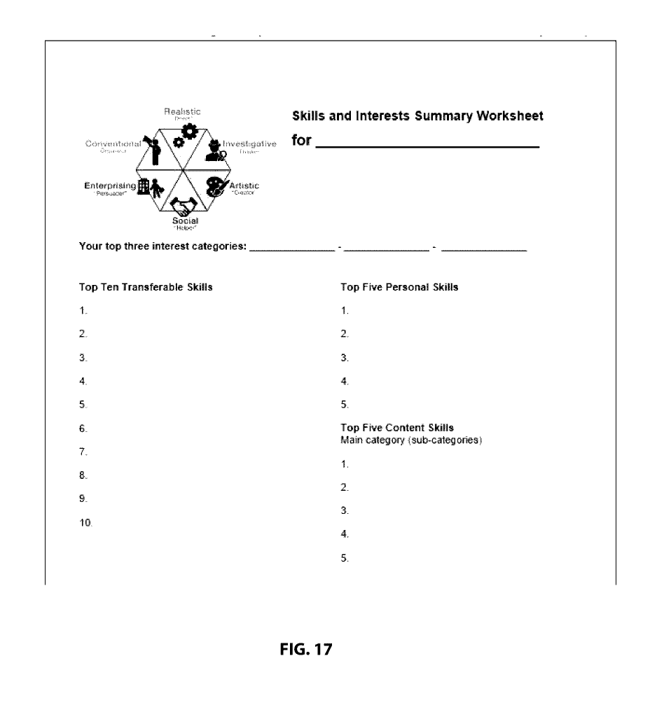

FIG. 17 is a screen shot of an example skills and interests summary worksheet for a network based exemplification on the present tool and method.

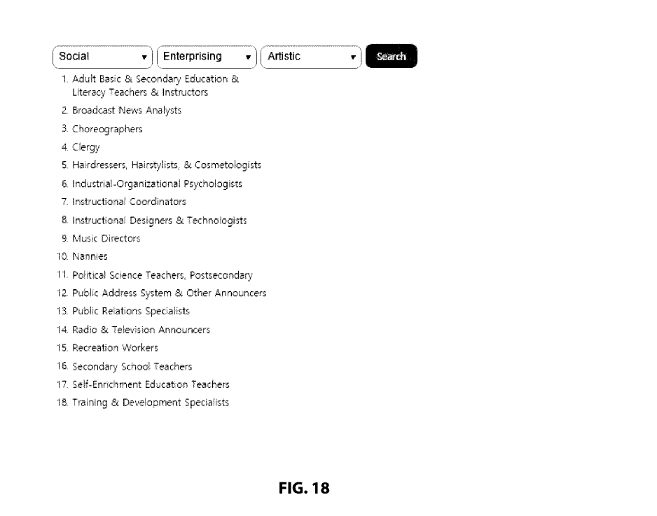

FIG. 18 is a screen shot of an example results page for a Social-Enterprising-Artistic result showing careers frequented by individuals designated as such.

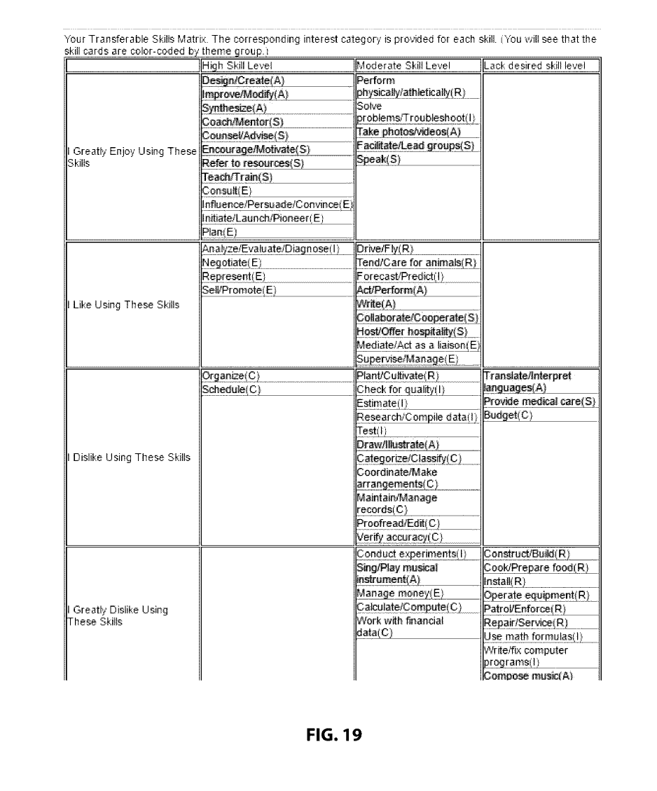

FIG. 19 is a screen shot of an example results matrix for sorted transferable skills.

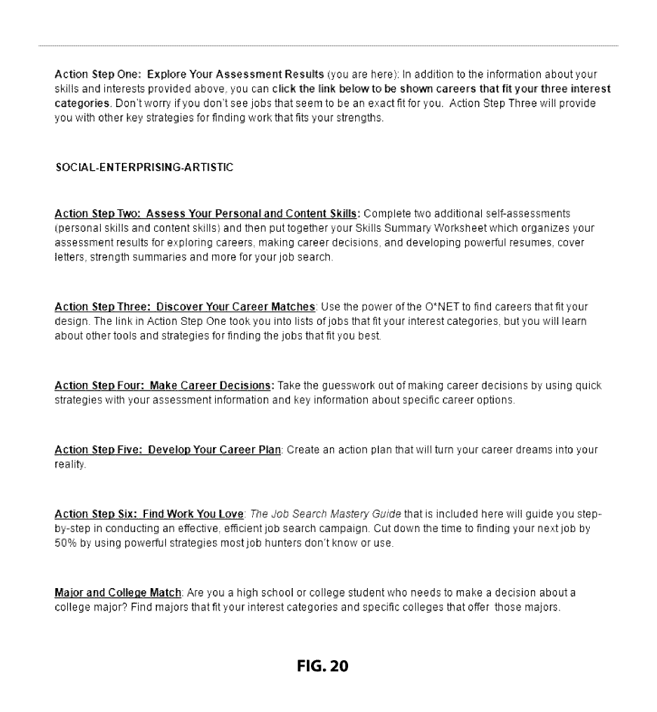

FIG. 20 is a screen shot of an example results page, showing the Holland Code designation of the user.

### DETAILED DESCRIPTION OF THE DRAWINGS

With reference now to the drawings, and in particular FIGS. 1 through 20 thereof, example of the instant skill set and career assessment tool and method employing the principles and concepts of the present skill set and career assessment tool and method and generally designated by the reference number will be described.

Referring to FIGS. 1 through 20 a preferred embodiment of the skill set and career assessment tool and method is illustrated.

The present skill set and career assessment tool and method has been devised to enable selection, itemization, and ranking of proficiency of various skills by a user, to sequence preferred skills relative less preferred skills, and thence generate a results code applicable to automate search of career paths, career and job descriptions, available openings in jobs, courses of study, or volunteer opportunities, among other openings and opportunities, matchable relative the results code generated for any particular user. Career, educational courses, and job descriptions may be directed to particular careers, or positions or jobs in a particular career, whereby a user is enabled to explore potential careers and courses of study that would yield enjoyment and satisfaction. Opportunities and openings may be listed by institutions, educational organizations, colleges and schools, businesses, churches, fraternal organizations, and volunteer organizations, among other institutions and corporations.

The present skill set and career assessment tool and method enables sorting of a plurality of transferable skills between rankings of preference level (and thus enjoyment a user experiences when leveraging a particular skill) as well as by competency. Thus, fulfilling opportunities based on enjoyment and proficiency are discoverable for a user, said opportunities matched according to a user's level of preference and competence. A user may then browse through itemized results and explore potential careers matched to their preference and competency. In some instances, a user may also apply to a particular result for a job opening that meets said user's fancy.

The present skill set and career assessment tool and method, therefore, presents a user with a plurality of transferable skills itemized for selection and ranking into one of a plurality of categories. Each of the skills includes metadata that originates them under a particular designation. In an example embodiment set forth herein, the plurality of transferable skills includes sixty named skills from six designations and the plurality of categories includes four categories, wherein a user may rank the level of enjoyment a user experiences when leveraging each transferable skill from a maximum preference, titled for example “I greatly enjoy using these skills”, to a minimum preference, titled for example “I greatly dislike using these skills” (see for example FIG. 3).

An exemplary sixty transferable skills are listed below, and shown by designation in FIG. 2. Each designation comprises ten skills. The designations are REALISTIC (R), INVESTIGATIVE (I), ARTISTIC (A), ENTERPRISING (E), SOCIAL (S), and CONVENTIONAL (C). These same skills and designations are shown in a ranked matrix in FIGS. 4 and 19., said matrix representing the end result of a user ranking and sorting said skills by preference level and competency level.

Realistic [R]

### Patrol/Enforce (R)

### Repair/Service (R)

### Install (R)

Cook/Prepare food (R)

### Construct/Build (R)

### Plant/Cultivate (R)

Operate equipment (R)
Tend/Care for animals (R)

### Drive/Fly (R)

Perform physically/athletically (R)

Investigative [I]

Write/fix computer programs (I)
Use math formulas (I)
Conduct experiments (I)

### Test (I)

Research/Compile data (I)

### Estimate (I)

### Analyze/Evaluate/Diagnose (I)

Check for quality (I)
Solve problems/Troubleshoot (I)

### Forecast/Predict (I)

Artistic (A)

Compose music (A)
Translate/Interpret languages (A)
Sing/Play musical instrument (A)

### Act/Perform (A)

### Write (A)

### Draw/Illustrate (A)

### Improve/Modify (A)

Take photos/videos (A)

### Synthesize (A)

### Design/Create (A)

Enterprising [E]

### Supervise/Manage (E)

Manage money (E)
Mediate/Act as a liaison (E)

### Represent (E)

### Negotiate (E)

### Plan (E)

### Sell/Promote (E)

### Initiate/Launch/Pioneer (E)

### Influence/Persuade/Convince (E)

### Consult (E)

Social [S]

Provide medical care (S)
Host/Offer hospitality (S)

### Collaborate/Cooperate (S)

### Speak (S)

Facilitate/Lead groups (S)

### Teach/Train (S)

Refer to resources (S)

### Encourage/Motivate (S)

### Counsel/Advise (S)

### Coach/Mentor (S)

Conventional [C]

Work with financial data (C)

### Categorize/Classify (C)

### Budget (C)

### Organize (C)

Maintain/Manage records (C)

### Calculate/Compute (C)

Verify accuracy (C)

### Proofread/Edit (C)

### Schedule (C)

Coordinate/Make arrangements (C)

Once each of the plurality of transferable skills has been ranked into one of the plurality of preference levels (see for example FIG. 3), a user then proceeds to sort the transferable skills based on competency by sorting each of the transferable skills into a plurality of competency levels. In the example embodiment set forth herein there are three competency levels set forth, ranked from “High Skill Level”, “Moderate Skill Level”, to the least “Little or No Skill Level”.

Each of the transferable skills is thereby determinable by compound rank of level of preference and level of competency (see, for example, FIG. 4). If a user demarks a particular skill at a high level of preference, but a low competency level, then a user is prompted to explore developing that skill. If a user demarks a skill at a high level of competency, but a low level of preference, then the skill is listed as a “killer skill”—a skill which, if developed, may lead to material satisfaction but not personal fulfillment. These “killer skills” may represent a temptation to be avoided.

Once each of the plurality of transferable skills has been ranked according to preference and also competency, a user then selects a favorite ten of the transferable skills and prioritizes them from one to ten, from most favorite to least favorite (see for example FIG. 4).

Once the selection of the ten favorite transferable skills has been made and prioritized from favorite to least favorite, a user is provided with a code generated from the selections made throughout the process, a key to understand the code and the results generated, and then matched with career descriptions and associated positions and/or available opportunities via network enabled search.

The present skill set and career assessment tool and method is contemplated to be presented and automated by computer in network connection, although tangible sorting of actual physical cards, or other sortable objects patterned in space, is contemplated as part of this invention. Generation of the code is thereby automatable, and may be configured as a known code type. In the example embodiment herein disclosed, the code is contemplated to be a three-lettered Holland code by which Internet or other network search through career descriptions and available opportunities listed online is rapidly matchable to a candidate's particular results. In an example embodiment, the code is matchable to listings and career descriptions searchable at the Onet Online website. In this example, the Holland code is generated based on the ten favorite skills. Skill designations are summed, and the designation with most representation in the ten favorite skills is positioned first. Thus, if a user had five “Artistic” skills in the ten favorite skills, the letter A would be generated first. If a user then, for example, had three “Social” skills represented in the ten favorite skills and a remaining two “Investigative”, then the generated code generated would be “A-S-I”. See for example FIG. 6.

Where skill designations are matched, the priority order given to one skill relative another is taken into consideration. Thus, in the above example, if instead of two “Investigative” skills represented in the ten favorite skills, one “Investigative” and one “Realistic”, for example, were selected then the skill with greater priority in the listed ten would receive favor. Thus, if the “Realistic” skill had a rank of 4 out of 10, for example, and the “Investigative” had a rank of 8 out of ten, then the generated code would be “A-S-R”.

Career descriptions, job position requirements, courses of study, and any opportunities and openings returned as part of the network search, are displayed as links whereby descriptions of the particular positions, courses, and careers, and any opportunities and openings, are accessible when a user selects a particular result and more information pertaining to adopting said career or job position, including requirements in education and proficiency and/or work experience, is thereby ascertainable. A user may, therefore, determine career choices and explore career opportunities to determine a career path suited to personal fulfillment. Application to each opportunity and opening, when present, may likewise be enabled through the returned results.

As shown in FIG. 17, for additional assistance in comprehending and applying data returned, results of ranking and sorting the skills and prioritizing the top ten skills are displayable automatically as a Skills and Interests Summary Worksheet usable by a user to make career decisions based on the top ten prioritized skills and career matches, develop career and educational plans, and develop job search tools including targeted resumes, cover letters, and profiles connected to social media.

What is claimed is:

1. A skill set and career assessment tool and method operational through a graphical user interface displayable upon a networked computing device, said method comprising the steps of:
presenting a list of transferable skills to a user for manual sorting into each of an enjoyment/interest category by preference;
presenting the list of transferable skills to the user for manual sorting into each of a level of competence;
presenting the list of transferable skills to the user for manual prioritizing of ten preferred skills, ranked from most favorite skill to least favorite skill; and
generating a results code determinable from the user sorting and ranking the list of transferrable skills, said code applicable to automate search over network and match the user with results data suited to the skills previously selected and ranked;
wherein the user is afforded results relevant to both said user's competence and enjoyment in wielding determined skills relative a particular position, job, career path, course of study, or volunteer opportunity.

2. The skill set and career assessment tool and method of claim 1 wherein a list of skills sorted and ranked by the user suggestive of competence but low enjoyment are presented as “killer skills” which, if practiced, would lead to an unhappy and unfulfilling position.

3. The skill set and career assessment tool and method of claim 2 wherein the list of transferable skills presented to the user are grouped between six designations, said designations consisting of:
a Realistic designation;
an Investigative designation;
an Artistic designation;
a Social designation;
an Enterprising designation; and
a Conventional designation;
wherein each of said designations consists of ten skills.

4. The skill set and career assessment tool and method of claim 3 wherein the enjoyment/interest categories consist of:
a highest enjoyment category;
a high enjoyment category;
a low enjoyment category; and
a lowest enjoyment category.

5. The skill set and career assessment tool and method of claim 4 wherein the competence levels consist essentially of:
a high skill level;
a moderate skill level; and
a lack of skill level.

6. The skill set and career assessment tool and method of claim 5 wherein the code generated by user sorting and ranking skills is a three-lettered Holland code usable to match the user preference and competency to career and job descriptions, courses of study, and available positions listed remotely and searchable over the internet.

7. The skill set and career assessment tool and method of claim 6 wherein the results returned generate a Skills and Interests Summary Worksheet.

8. The skill set and career assessment tool and method of claim 7 wherein the results generated to match a particular user's sorted and ranked skills enable a user to explore each result.

9. A skill set and career assessment tool and method operational through a graphical user interface displayable upon a networked computing device, said method comprising the steps of:
presenting a list of sixty transferable skills to a user, each of said sixty transferable skills having one of four designations consisting of Realistic, Investigative, Artistic, Social, Enterprising and Conventional;
prompting the user to effect sorting of each of said sixty transferable skills into one of four enjoyment/interest categories by preference, said enjoyment/interest categories consisting of a highest enjoyment category, a high enjoyment category, a low enjoyment category, and a lowest enjoyment category;
prompting the user to effect sorting of each of said sixty transferable skills to effect sorting of each of said sixty transferable skills into one of three levels of competence, said levels of competence consisting essentially of a high skill level, a moderate skill level, and no skill level;
presenting the list of sixty transferable skills to the user for manual prioritizing of a top ten preferred skills, said top ten preferred skills ranked from most favorite skill to least favorite skill; and
generating a code determinable from the sorting and ranking action, said code usable to automate search over network and match the user with a results matched to the code indicative of user competency and enjoyment;
wherein the user is afforded results relevant to both said user's competence and enjoyment in wielding determined skills relative a particular position, job, career path, course of study, or volunteer opportunity searchable over the internet, and, further, wherein skills determined to be highest in competence but lowest in enjoyment are listed as avoidable “killer skills” matched to results that, while potentially meeting the user's particular talents, are nonetheless likely to be unfulfilling for the user.
